(19) United States
(12) Patent Application Publication
(10) Pub. No.: US 2025/0016624 A1
(43) Pub. Date: Jan. 9, 2025

(54) SENSING PROCESSING METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventors: Shengli DING, Dongguan (CN); Dajie JIANG, Dongguan (CN)

(73) Assignee: VIVO MOBILE COMMUNICATION CO., LTD., Dongguan (CN)

(21) Appl. No.: 18/889,336

(22) Filed: Sep. 18, 2024

Related U.S. Application Data
(63) Continuation of application No. PCT/CN2023/081701, filed on Mar. 15, 2023.

(30) Foreign Application Priority Data
Mar. 18, 2022 (CN) 202210273500.7

(51) Int. Cl. H04W 28/18; H04W 28/02

(52) U.S. Cl. CPC H04W 28/18; H04W 28/0268

(57) ABSTRACT

A sensing processing method and a communication device are provided. The sensing processing method includes: obtaining, by a first device, target information. The target information is determined based on a result obtained by executing a first sensing service. The sensing processing method further includes determining, by the first device, a signal parameter of a first signal according to the target information. The first signal is used to execute the first sensing service.

### CROSS-REFERENCE TO RELATED APPLICATIONS

This application is a continuation of International Application No. PCT/CN2023/081701, filed on Mar. 15, 2023, which claims priority to Chinese Patent Application No. 202210273500.7, filed on Mar. 18, 2022 in China. The entire contents of each of the above-referenced applications are expressly incorporated herein by reference.

### TECHNICAL FIELD

This application pertains to the field of communication technologies, and specifically relates to a sensing processing method and apparatus, a communication device, and a readable storage medium.

### BACKGROUND

With the development of communication technologies, integrated sensing and communication can be implemented in a communication system. In an integrated sensing and communication scenario, there are two types of services: communication and sensing. Currently, in a conventional sensing scenario, a fixed signal parameter is generally used to execute a sensing service. In the integrated sensing and communication scenario, because there is a communication service and/or one or more sensing services, and communication load or sensing scenarios are constantly changing, poor sensing performance is easily caused when a sensing service is executed by using the fixed signal parameter.

### SUMMARY

According to a first aspect, a sensing processing method is provided, including:
obtaining, by a first device, target information, where the target information is determined based on a result obtained by executing a first sensing service; and
determining, by the first device, a signal parameter of a first signal according to the target information, where the first signal is used to execute the first sensing service.

According to a second aspect, a sensing processing method is provided, including:
receiving, by a second device, first indication information from a first device, where the first indication information is used to indicate an adjusted signal parameter of a first signal, and the first signal is used to execute a first sensing service; and
executing, by the second device, a first operation based on the adjusted signal parameter, where
the first operation includes any one of the following:
in a case that the second device is a first sensing function network element, executing, according to the adjusted signal parameter, second arithmetic on echo data received from the first device, to obtain target information, where the echo data is echo data obtained by the first device by executing the first sensing service based on the adjusted signal parameter;
in a case that the second device is the first sensing function network element, executing, according to the adjusted signal parameter, third arithmetic on an intermediate sensing result received from the first device, to obtain the target information, where the intermediate sensing result is a result obtained by the first device by executing first arithmetic on the echo data, the first arithmetic is a part of the second arithmetic, and the third arithmetic is remaining arithmetic other than the first arithmetic in the second arithmetic; and
in a case that the second device is a first sensing node, sending and/or receiving the first signal according to the adjusted signal parameter.

According to a third aspect, a sensing processing apparatus is provided, applied to a first device and including:
an obtaining module, configured to obtain target information, where the target information is determined based on a result obtained by executing a first sensing service; and
an adjustment module, configured to determine a signal parameter of a first signal according to the target information, where the first signal is used to execute the first sensing service.

According to a fourth aspect, a sensing processing apparatus is provided, applied to a second device and including:
a first receiving module, configured to receive first indication information from a first device, where the first indication information is used to indicate an adjusted signal parameter of a first signal, and the first signal is used to execute a first sensing service; and
a first execution module, configured to execute a first operation based on the adjusted signal parameter, where
the first operation includes any one of the following:
in a case that the second device is a first sensing function network element, executing, according to the adjusted signal parameter, second arithmetic on echo data received from the first device, to obtain target information, where the echo data is echo data obtained by the first device by executing the first sensing service based on the adjusted signal parameter;
in a case that the second device is the first sensing function network element, executing, according to the adjusted signal parameter, third arithmetic on an intermediate sensing result received from the first device, to obtain the target information, where the intermediate sensing result is a result obtained by the first device by executing first arithmetic on the echo data, the first arithmetic is a part of the second arithmetic, and the third arithmetic is remaining arithmetic other than the first arithmetic in the second arithmetic; and
in a case that the second device is a first sensing node, sending and/or receiving the first signal according to the adjusted signal parameter.

According to a fifth aspect, a communication device is provided. The communication device includes a processor and a memory, the memory stores a program or an instruction that can be run on the processor, and the program or the instruction is executed by the processor to implement the steps of the method according to the first aspect.

According to a sixth aspect, a communication device is provided, including a processor and a communication interface. When the communication device is a first device, the communication interface is configured to obtain target information, where the target information is determined based on a result obtained by executing a first sensing service; and the processor is configured to adjust a signal parameter of a first signal according to the target information, where the first signal is used to execute the first sensing service; or
when the communication device is a second device, the communication interface is configured to receive first indication information from a first device, where the first indication information is used to indicate an adjusted signal parameter of a first signal, and the first signal is used to execute a first sensing service; and the processor is configured to execute a first operation based on the adjusted signal parameter, where
the first operation includes any one of the following:
in a case that the second device is a first sensing function network element, executing, according to the adjusted signal parameter, second arithmetic on echo data received from the first device, to obtain target information, where the echo data is echo data obtained by the first device by executing the first sensing service based on the adjusted signal parameter;
in a case that the second device is the first sensing function network element, executing, according to the adjusted signal parameter, third arithmetic on an intermediate sensing result received from the first device, to obtain the target information, where the intermediate sensing result is a result obtained by the first device by executing first arithmetic on the echo data, the first arithmetic is a part of the second arithmetic, and the third arithmetic is remaining arithmetic other than the first arithmetic in the second arithmetic; and
in a case that the second device is a first sensing node, sending and/or receiving the first signal according to the adjusted signal parameter.

According to a seventh aspect, a communication system is provided, including a first device and a second device. The first device may be configured to execute the steps of the sensing processing method according to the first aspect, and the second device may be configured to execute the steps of the sensing processing method according to the second aspect.

According to an eighth aspect, a readable storage medium is provided. The readable storage medium stores a program or an instruction, and the program or the instruction is executed by a processor to implement the steps of the method according to the first aspect or the steps of the method according to the second aspect.

According to a ninth aspect, a chip is provided. The chip includes a processor and a communication interface, the communication interface is coupled to the processor, and the processor is configured to run a program or an instruction to implement the steps of the method according to the first aspect or the steps of the method according to the second aspect.

According to a tenth aspect, a computer program/program product is provided. The computer program/program product is stored in a storage medium, and the computer program/program product is executed by at least one processor to implement the steps of the method according to the first aspect or the steps of the method according to the second aspect.

### BRIEF DESCRIPTION OF DRAWINGS

FIG. 1 is a structural diagram of a network system to which the embodiments of this application are applicable;

FIG. 2 is a schematic flowchart of a sensing processing method according to an embodiment of this application;

FIG. 3 to FIG. 5 are example diagrams of different duration of a sensing update period in a sensing processing method according to an embodiment of this application;

FIG. 6 is a schematic flowchart of another sensing processing method according to an embodiment of this application;

FIG. 7 is a structural diagram of a sensing processing apparatus according to an embodiment of this application;

FIG. 8 is a structural diagram of another sensing processing apparatus according to an embodiment of this application;

FIG. 9 is a structural diagram of a communication device according to an embodiment of this application;

FIG. 10 is a structural diagram of a terminal according to an embodiment of this application; and

FIG. 11 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

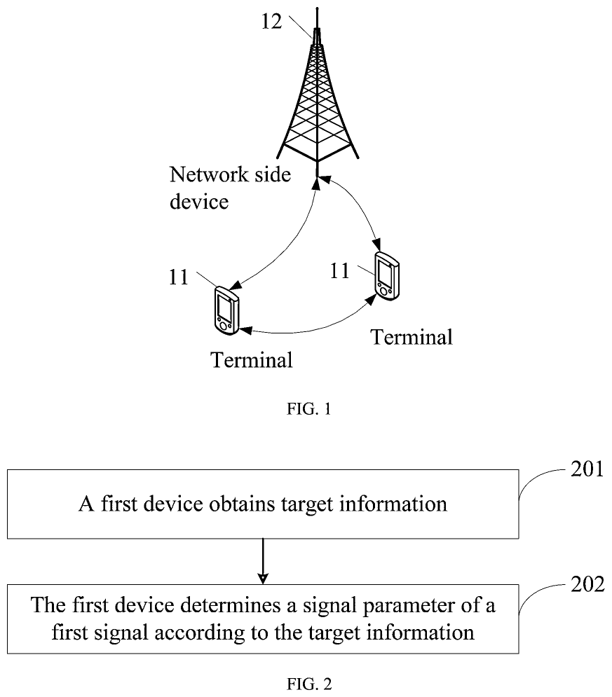

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNB, a Transmission Reception Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rule Function (PCRF) unit, an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

For ease of understanding, the following describes some content in the embodiments of this application.

### I. Integrated Sensing and Communication

Integrated sensing and communication may also be referred to as Integrated Sensing And Communication (ISAC). In the ISAC, integration of communication and sensing functions is achieved in low costs in a manner of sharing a hardware device and a software-defined function. Main features of the ISAC are: a unified and simplified architecture, reconfigurable and scalable functions, and improved efficiency and reduced costs. There are three main advantages of the integrated sensing and communication: reducing device costs and dimensions, improving spectrum utilization, and improving system performance.

Development of the ISAC is divided into four stages: co-existence, co-operation, co-design, and co-collaboration.

Co-existence: Communication and sensing are two mutually separate systems, and the two systems interfere with each other. Main methods for resolving interference are distance isolation, band isolation, time division operation, a Multiple Input Multiple Output (MIMO) technology, precoding, and the like.

Co-operation: Communication and sensing share a hardware platform, and improve common performance by using common information. Power allocation between the two greatly affects system performance.

Co-design: Communication and sensing become a fully joint system, including a joint signal design, a joint waveform design, a joint coding design, and the like. In an earlier period, there are a linear frequency modulation waveform, a spread spectrum waveform, and the like, and later, the focus is shifted to an Orthogonal Frequency Division Multiplexing (OFDM) waveform, a MIMO technology, and the like.

Co-collaboration: A plurality of integrated sensing and communication nodes cooperate with each other to implement a common objective. For example, a typical scenario in which radar detection information is shared by means of communication data transmission includes a driver assistant system, radar auxiliary communication, and the like.

### 2. Radar Technology

With the development of the radar technology, a radar detection target is not only a distance of a measurement target, but also a speed, an azimuth, and a pitch angle of the measurement target, and more information about the target, including a size and a shape of the target, is extracted from the foregoing information.

The radar technology was originally used for military purposes to detect targets such as an aircraft, a missile, a vehicle, and a ship. With the development of technology and the evolution of society, the radar is increasingly used in civil scenarios. A typical application is that a weather radar forecasts the weather by measuring an echo of meteorological targets such as clouds and rain to determine a location and an intensity of the clouds and rain. Further, with the flourishing development of an electronic information industry, the Internet of Things, a communication technology, and the like, the radar technology starts to enter daily life applications of people, which greatly improves convenience and security of work and life. For example, a vehicle radar provides warning information for driving of vehicles by measuring a distance and a relative speed between vehicles, between vehicles and surrounding environment objects, and between vehicles and pedestrians, thereby greatly improving road traffic safety.

At a technical level, radars are classified in many manners. The radars may be classified into a single-station radar and a dual-station radar based on a location relationship between transmitting and receiving stations of the radars. For the single-station radar, a signal transmitter is integrated with a receiver and the two share an antenna. An advantage is that a target echo signal is naturally coherent with a local oscillator of the receiver, and signal processing is convenient. A disadvantage is that signal receiving and sending cannot be simultaneously executed, and only a signal waveform with a specified duty ratio can be used, thus bringing a blind spot for detection, which needs to be remedied by a complex algorithm; or signal receiving and sending are simultaneously executed, and receiving and sending are strictly isolated, but it is difficult to achieve for a high-power military radar. For the dual-station radar, a signal transmitter and a receiver are located at different locations. An advantage is that signal receiving and sending can be simultaneously executed, and a continuous wave waveform may be used for detection. A disadvantage is that it is difficult to implement co-frequency and coherence between the receiver and the transmitter, and signal processing is relatively complex.

In a wireless sensing application of the integrated sensing and communication, the radar technology may use a single-station radar mode or a dual-station radar mode.

In the single-station radar mode, signal receiving and sending share an antenna, and a receive signal and a transmit signal enter different radio frequency processing links by using a circulator. In this mode, a continuous wave signal waveform may be used to detect a blind spot, provided that the receive signal and the transmit signal need to be isolated from each other. Generally, an isolation degree of about 100 dB is required, to eliminate submerging of the receive signal by leakage of the transmit signal. Because a receiver of the single-station radar has all information of the transmit signal, signal processing may be executed in a manner of matching filtering (pulse compression) to obtain a relatively high signal processing gain.

In the dual-station radar mode, there is no isolation problem between a receive signal and a transmit signal, greatly simplifying hardware complexity. Since radar signal processing is based on known information, in an integrated sensing and communication application of 5G NR, known information such as a synchronization signal and a reference signal may be used for radar signal processing. However, due to periodicity of the synchronization signal, the reference signal, and the like, a fuzzy diagram of a signal waveform is no longer a thumbtack shape, but a pin-board shape. Ambiguity of delay and Doppler increases, and a gain of a main lobe is much lower than that in the single-station radar mode, reducing distance and speed measurement ranges. By means of a proper parameter set design, the distance and speed measurement ranges can meet measurement requirements of common targets such as vehicles and pedestrians. In addition, measurement precision of the dual-station radar is related to a location of a transceiver station relative to a target, and a proper transceiver station pair needs to be selected to improve detection performance.

With reference to the accompanying drawings, the following describes in detail the sensing processing method provided in the embodiments of this application by using some embodiments and application scenarios thereof.

Referring to FIG. 2, an embodiment of this application provides a sensing processing method. As shown in FIG. 2, the sensing processing method includes:

Step 201: A first device obtains target information, where the target information is determined based on a result obtained by executing a first sensing service.

In this embodiment of this application, the target information may include at least one of the following: echo signal quality, a first parameter, and a first indicator of the first parameter.

The echo signal quality may include or represent at least one of the following: an echo signal power, an echo Signal-to-Noise Ratio (SNR), an echo Signal to Interference Plus Noise Ratio (SINR), a Reference Signal Received Power (RSRP), and Reference Signal Received Quality (RSRQ).

In some embodiments, the echo signal quality may be calculated based on a signal of at least one of the following resource ranges:
a time dimension: a sensing signal period or a sensing frame period;
a frequency range: one or more delay resolution units, or a preset delay range;
a Doppler dimension: one or more Doppler units, or a preset Doppler range;
an angle dimension: one or more angle resolution units, or a preset angle range; and
an energy dimension: a preset signal amplitude or power range.

In some embodiments, the first parameter may include at least one of the following: a parameter in a polar coordinate system and a parameter in a rectangular coordinate system.

The parameter in the polar coordinate system may be understood as a parameter directly obtained based on sensing in the polar coordinate system, and includes at least one of the following: a radial distance of a sensing object relative to a sensing node, a radial speed of the sensing object relative to the sensing node, and an angle of the sensing object relative to the sensing node. The angle may further include a direction angle and a pitch angle.

The parameter in the rectangular coordinate system may be understood as a parameter in the rectangular coordinate system after coordinate transformation, and includes at least one of the following: coordinates of the sensing object in the rectangular coordinate system (for example, an x-axis coordinate, a y-axis coordinate, and a z-axis coordinate) and a speed of the sensing object in the rectangular coordinate system (for example, an x-direction speed, a y-direction speed, and a z-direction speed).

In some embodiments, the first indicator may be obtained based on the first parameter through data processing, and may include at least one of the following: a variance or a standard deviation of a residual, a covariance of a prediction error; and a covariance of a state estimation error.

The residual is a difference between a measurement value of a second sensing frame for the first parameter and a prediction value of a first sensing frame for the first parameter corresponding to the second sensing frame; and the variance or the standard deviation of the residual may be calculated in a sliding window manner. The first sensing frame may be understood as a sensing frame that currently executes sensing measurement, and the second sensing frame may be understood as a sensing frame located after the first sensing frame.

A covariance of a prediction error of the first parameter is obtained in a process of executing a prediction algorithm, and a covariance of a state estimation error of the first parameter is obtained in a process of executing a filtering algorithm.

In some embodiments, the target information may be understood as a target sensing result. That is, echo data is obtained by executing sensing measurement on a sensing object by using a first signal, and the target sensing result is obtained by executing arithmetic based on the echo data.

Step 202: The first device determines a signal parameter of a first signal according to the target information, where the first signal is used to execute the first sensing service.

The first signal may be understood as a sensing signal or an integrated sensing and communication. The first device may be a first sensing node or a first sensing function network element, which is not further limited herein. The first sensing node may be understood as a sensing node or a sensing device for executing the first sensing service, and may include at least one of a sending device and a receiving device.

In this embodiment of this application, that the first device determines a signal parameter of a first signal according to the target information may be understood as that the first device adaptively adjusts the signal parameter of the first signal according to the target information. The determined signal parameter may be referred to as an adjusted signal parameter.

It should be understood that, a sensing function network element (for example, a first sensing function network element, a second sensing function network element, or a third sensing function network element) in this embodiment of this application is a network node that is responsible for at least one function such as sensing request processing, sensing resource scheduling, sensing information exchange, or sensing data processing in a core network and/or a radio access network, and may be upgraded based on an AMF or an LMF in an existing 5G network, or may be another network node or a newly defined network node.

In this embodiment of this application, in a case that the target information is obtained, the signal parameter of the first signal may be adjusted based on the target information, so that the signal parameter of the first signal can be flexibly adjusted based on a current sensing environment.

In this way, the signal parameter that is of the first signal and that is used to execute sensing in an integrated sensing and communication scenario can be optimized on a premise that a requirement for a sensing performance indicator is met. Therefore, the embodiments of this application can improve sensing performance.

In some embodiments, the signal parameters may include at least two of the following: first time resource information, a sensing signal period, a sensing update period, a sensing frame period, a bandwidth, an antenna aperture, a transmit power, and a beam direction.

In some embodiments, the first time resource information includes any one of the following:
a fixed time resource for being allocated to the first sensing service; and
a time unit and a time resource allocation ratio that is used to execute the first sensing service within the time unit.

In this embodiment of this application, the fixed time resource may be allocated to execute a current sensing service. This time resource configuration manner is based on dividing a time resource according to a granularity. The granularity may be a time unit such as an OFDM symbol period, a slot, a half frame or frame, or a second, a millisecond, or a microsecond in a 5G communication service. For example, allocation may be executed in the following manner:

1. Bitmap manner: A time resource allocated to a sensing service is configured in a bitmap manner, where 1 in the bitmap represents a corresponding time resource to be allocated to the sensing service, and 0 in the bitmap represents a corresponding time resource not to be allocated to the sensing service. In this manner, any type of continuous or discontinuous, or periodic or aperiodic time resources may be configured.

2. A length plus period manner: A length of each segment of time resource to be allocated to a sensing service is specified, and a period of each segment of time resource to be allocated to the sensing service is given. In this manner, periodic time resources may be configured. In some embodiments, this time resource configuration manner may further include an offset of each segment of time resource allocated to the sensing service relative to a time point.

In some embodiments, a time length of the sensing signal period is equal to a time length of a corresponding sensing signal in which a sensing node performs one time of fast-time dimensional signal processing on the first signal. The one time of fast-time dimensional signal processing on the first signal may be understood as signal processing on the first signal within one signal period.

In some embodiments, the sensing update period may be understood as a time interval between a corresponding time for which a sensing node performs one time of slow-time dimensional signal processing on the first signal within an M1^{th} sensing frame period and obtains a first parameter of a sensing object and a corresponding time for which a sensing node performs one time of slow-time dimensional signal processing on the signal within an M2^{th} sensing frame period and obtains a first parameter of a sensing object. Both M1 and M2 are positive integers, a difference between M2 and M1 is equal to a quantity of sensing frame periods included in the sensing update period, and the first parameter is used to indicate at least one of location information and motion information of the sensing object. The one time of slow-time dimensional signal processing on the first signal may be understood as signal processing on the first signal in all sensing signal periods within one sensing frame period.

In some embodiments, the sensing frame period may be understood as a time length required by a sensing node to perform one time of slow-time dimensional signal processing on the first signal and obtain a first parameter of a sensing object. For example, the sensing frame period may include a first slot and a second slot. The first slot may include a plurality of sensing signal periods, and the second slot may be understood as an integrated processing slot used for tasks such as signal processing, resource scheduling, and signal waveform generation.

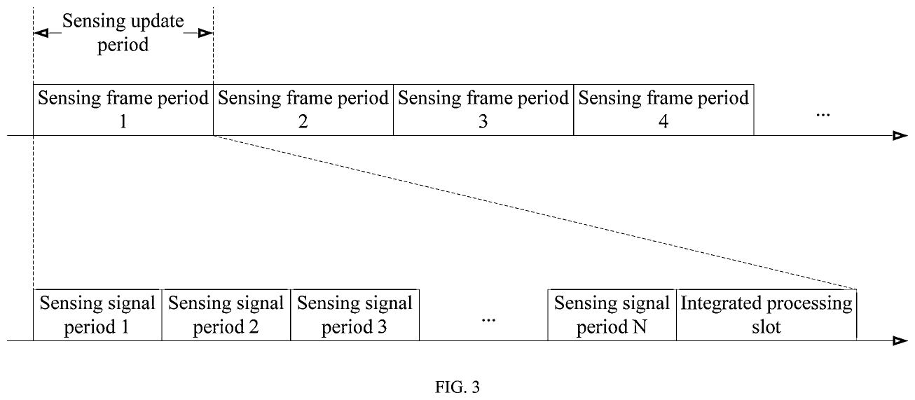

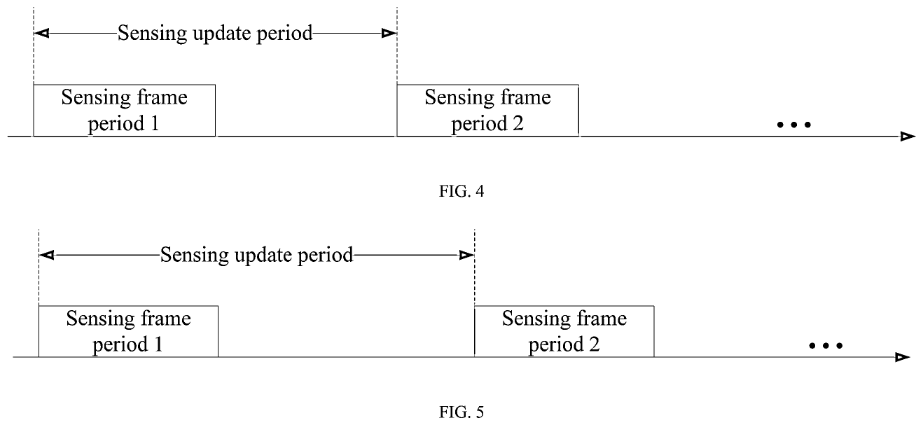

In the following embodiments, an example in which one sensing frame period is included in one sensing update period is used for description. For example, a time correspondence between a sensing update period and a sensing frame period is shown in FIG. 3 to FIG. 5. In FIG. 3, duration of the sensing update period is a time interval between a start moment or an end moment of two adjacent sensing frame periods. In FIG. 4, duration of the sensing update period is equal to an integer multiple of duration of the sensing frame period. In FIG. 5, duration of the sensing update period is equal to any value, and the sensing update period is greater than or equal to an integer multiple of duration of the sensing frame period.

In some embodiments, before the obtaining, by a first device, target information, the method further includes:
obtaining, by the first device, first information; and
determining, by the first device, an initial configuration of the signal parameter of the first signal according to the first information, and capability information and location information that are of a first sensing node, where the initial configuration is used to execute initial sensing; and
the first sensing node is the first device, or the first sensing node is a sensing node invoked by the first device to execute the first sensing service; and the first information includes at least one of the following: a sensing service type, an execution time of a sensing service, a global priority of a sensing service, a sensing object type, sensing prior information, a sensing measurement quantity, a sensing Quality of Service (QOS) requirement, a signal processing algorithm, and a data processing algorithm.

In this embodiment of this application, when the signal parameter of the first signal is adjusted, a configuration before the signal parameter of the first signal is adjusted may be the initial configuration or a configuration after the initial configuration is adjusted one or more times. For example, a configuration of a signal parameter corresponding to the first sensing frame may be adjusted to obtain a configuration of a signal parameter corresponding to the second sensing frame.

In some embodiments, the sensing service type may include at least one of the following or be determined based on at least one of the following: distance measurement, speed measurement, angle measurement, imaging, target tracking, and target/state identification.

In some embodiments, the execution time of the sensing service may be understood as a time point or a time range at which the sensing service is expected to be executed.

In some embodiments, the global priority of the sensing service may be understood as a global priority of the sensing service in an integrated sensing and communication network, and resources such as a device, an aperture, a power, a time, and a frequency may be occupied by a high-priority sensing service.

In some embodiments, the sensing object type may be determined based on at least one of the following: a motion speed of a typical sensing object, and a motion acceleration and a Radar Cross-Section (RCS) of the typical sensing object. That is, the sensing object type includes information such as the motion speed of the typical sensing object and the motion acceleration and the typical RCS of the typical sensing object. The typical RCS may be understood as a reflection cross-sectional area of the sensing object.

In some embodiments, the sensing prior information is information that is provided for a sensing node about a spatial range and/or a motion attribute of a sensing object or a sensing target region and that helps the sensing node narrow a search range, and includes at least one of the following:
spatial range prior information, such as a distance or a location range, and/or an angle range of a to-be-sensed object or a sensing target region; and
motion attribute prior information, such as a speed range and/or an acceleration range of a to-be-sensed object.

In some embodiments, location information of a sensing node may include the following two cases:

For a sensing node at a fixed location such as a base station or a TRP, location information of the sensing node is known, and the location information of the sensing node may be obtained by accessing a network function (for example, a network management system or unified data management) that stores the location information of the sensing node, or may be reported by the sensing node.

For a mobile sensing node such as a terminal, before executing sensing measurement, a sensing function network element needs to first obtain location information of the sensing node, and a method for obtaining the location information may be requesting and obtaining the location information from a positioning management function or another service function. The location management function may be a Location Management Function (LMF) function, and a network function that receives Minimization of Drive Test (MDT) location information. The positioning service function may be an Application Function (AF), and the AF may be a positioning server such as Wi-Fi, Bluetooth, or Ultra-Wideband (UWB), or may be an application function that can obtain positioning information such as a Global Positioning System (GPS), for example, a maps Application (APP).

In some embodiments, the sensing measurement quantity may include at least one of the following:
original channel information: compressed quantization information of a channel matrix H or H, and Channel State Information (CSI), for example, an amplitude/a square and/or a phase of an amplitude of a frequency domain channel response, or I-channel and Q-channel signal characteristics of a frequency domain channel response, for example, an amplitude/a square of an amplitude of an I-channel and/or a Q-channel signal;
signal strength information: an RSRP and a Received Signal Strength Indication (RSSI);
spectrum information: a channel Power Delay Profile (PDP), a Doppler power spectrum, a Power Azimuth Spectrum (PAS), pseudo-spectrum information, a delay-Doppler two-dimensional spectrum, and a delay-Doppler-azimuth three-dimensional spectrum;
sensing point cloud information;
multipath information: power, phase, delay, and angle information of each path (including at least a first-arrival path, an LOS path, a first-order reflection path, or a multi-order reflection path) in a multipath channel;
angle information: including an angle of arrival and an angle of departure;
difference information of signals corresponding to different antennas: a quotient or a conjugate product of frequency domain channel responses of a first antenna and a second antenna (or an amplitude or a phase of the quotient or the conjugate product of the frequency domain channel responses of the first antenna and the second antenna, or an I channel or a Q channel of the quotient or the conjugate product of the frequency domain channel responses of the first antenna and the second antenna, or projection arithmetic of the I channel or the Q channel of the quotient or the conjugate product of the frequency domain channel responses of the first antenna and the second antenna, where the projection arithmetic may be I*cos (theta)+Q*sin (theta), where theta is an angle value, different theta corresponds to different projections, I represents I-channel data, and Q represents Q-channel data), an amplitude ratio or an amplitude difference of receiving signals of the first antenna and the second antenna, a phase difference between signals of the first antenna and the second antenna, and a delay difference between signals of the first antenna and the second antenna; and
information about the first parameter determined based on the original channel information: a Doppler spread, a Doppler frequency shift, a maximum delay spread, an angle spread, a coherence bandwidth, and a coherent time.

In addition to the foregoing measurement quantity, a new measurement quantity generated by executing arithmetic based on two or more of the foregoing measurement quantity is included.

The sensing QoS requirement is a performance indicator for sensing a sensing target region or a sensing object, and may include at least one of the following: a sensing resolution requirement, a sensing precision requirement, a sensing range requirement, a sensing delay requirement, a sensing update rate requirement, a detection probability requirement, and a false alarm probability requirement. The sensing resolution requirement is further divided into a distance measurement resolution requirement, an angle measurement resolution requirement, a speed measurement resolution requirement, an imaging resolution requirement, and the like. The sensing precision requirement may be further divided into a distance measurement precision requirement, an angle measurement precision requirement, a speed measurement precision requirement, a positioning precision requirement, and the like. The sensing range requirement may be further divided into a distance measurement range requirement, a speed measurement range requirement, an angle measurement range requirement, an imaging range requirement, and the like. The sensing delay requirement may be understood as a requirement for a time interval from sending of a sensing signal to obtaining of a sensing result, or a requirement for a time interval from initiating of a sensing requirement to obtaining of a sensing result. The sensing update rate requirement may be understood as a requirement for a time interval at which two consecutive times of executing sensing and obtaining a sensing result. The detection probability requirement may be understood as a requirement for a probability of correctly detecting a sensing object in a case that the sensing object exists. The false alarm probability may be understood as a probability of incorrectly detecting a sensing object in a case that the sensing object does not exist.

In some embodiments, the signal processing algorithm is an algorithm for processing an echo signal to obtain the first parameter such as a distance, an angle, and a speed, for example, a Multiple Signal Classification (MUSIC) algorithm for executing angle super resolution, and a 2-Dimensional Fast Fourier Transform (2D-FFT) algorithm for executing distance and speed information.

In some embodiments, the data processing algorithm is further processing the first parameter obtained based on the signal processing algorithm, for example, executing Kalman filtering on the first parameter including a distance, an angle, and a speed of a sensing object, and executing a joint probability association algorithm for matching and associating a motion track of a sensing object.

In this embodiment of this application, if the first device is executed by the first sensing function network element, after determining the initial configuration, the first sensing function network element sends the initial configuration to the first sensing node that executes a sensing service. In an initial sensing phase, the first sensing node generates, sends, and receives the first signal according to the initial configuration of the signal parameter to obtain echo data, and the first sensing function network element and/or the first sensing node perform signal processing to obtain the target information. For example, the following cases may be included:

The first sensing node performs signal processing to obtain a sensing result. In some embodiments, the first sensing node sends the sensing result to the first sensing function network element.

The first sensing node executes partial arithmetic in signal processing to obtain an intermediate sensing result, and sends the intermediate sensing result and/or the echo data to the first sensing function network element, and the first sensing function network element performs remaining partial arithmetic in signal processing to obtain a sensing result. In some embodiments, the first sensing function network element sends the sensing result to the first sensing node.

The first sensing node sends the echo data to the first sensing function network element, and the first sensing function network element executes signal processing to obtain a sensing result. In some embodiments, the first sensing function network element sends the sensing result to the first sensing node.

Based on the foregoing different cases, for different first devices, corresponding behavior of obtaining the target information is different. For example, in some embodiments, the obtaining, by a first device, target information includes any one of the following:
in a case that the first device is the first sensing function network element, receiving, by the first device, second information from the first sensing node, and determining the target information based on the second information, where the second information includes echo data, an intermediate sensing result obtained by executing first arithmetic on the echo data, or the target information obtained by executing second arithmetic on the echo data, where the echo data is data obtained by the first sensing node by executing the first sensing service based on the current signal parameter, and the first arithmetic is a part of the second arithmetic;
in a case that the first device is the first sensing node, executing, by the first device, the first sensing service based on the current signal parameter to obtain the echo data, and executing the second arithmetic on the echo data to obtain the target information; and
in a case that the first device is the first sensing node, sending, by the first device, third information to the first sensing function network element, and receiving the target information sent by the first sensing function network element, where the third information includes the echo data or the intermediate sensing result obtained by executing the first arithmetic on the echo data, and the target information is target information determined by the first sensing function network element based on the third information.

In this embodiment of this application, when the first sensing function network element receives the echo data sent by the first sensing node, the first sensing function network element may execute the second arithmetic on the echo data to obtain the target information. When the first sensing function network element receives the intermediate sensing result sent by the first sensing node, the first sensing function network element may execute the third arithmetic on the intermediate sensing result to obtain the target information, where the third arithmetic is remaining arithmetic in the second arithmetic other than the first arithmetic.

In some embodiments, in a case that the first device is a first sensing function network element, before the determining, by the first device, an initial configuration of the signal parameter of the first signal according to the first information, and capability information and location information that are of a first sensing node, the method further includes:
determining, by the first device according to the first information, a first sensing node set used to execute the first sensing service and a second sensing node set used to execute the first sensing service after switching, where the first sensing node set includes at least one first sensing node, and the second sensing node set includes zero or at least one second sensing node.

In this embodiment of this application, the first sensing function network element may select, from one or more scheduled candidate devices according to the first information and location information and capability information of the candidate device, L sensing nodes to execute the first sensing service, where L is a positive integer. The L sensing nodes may be divided into two sets: the first sensing node set and the second sensing node set. The first sensing node included in the first sensing node set may be understood as a sensing node currently for executing the first sensing service, and the second sensing node included in the second sensing node set may be understood as a candidate sensing node for executing the first sensing service.

A selection method may be set according to an actual requirement. For example, in some embodiments, one of the following methods may be included:

Method 1: The first sensing function network element selects, according to the obtained capability information of the one or more candidate devices and with reference to the location information of the candidate device and the first information, the L sensing nodes to execute the first sensing service.

Method 2: The first sensing function network element sends the first information or a part of the first information to the one or more candidate devices, and the candidate device determines, according to the first information or the part of the first information and with reference to the location information of the candidate device, whether the first sensing service can be executed and sends second feedback information to the first sensing function network element, and the first sensing function network element selects, from candidate devices that can execute the first sensing service, the L sensing nodes to execute the first sensing service. The second feedback information is used to indicate whether the capability information of the candidate device can meet a requirement of the first sensing service.

For the foregoing method 1, that the first sensing function network element obtains capability information of a plurality of candidate devices may include the following cases:

Case 1: The capability information of the candidate device is reported in advance and stored in the first sensing function network element or a network node accessible to the first sensing function network element.

Case 2: After receiving capability information query information sent by the first sensing function network element, the candidate device reports the capability information to the first sensing function network element.

For the foregoing method 2, the first sensing function network element does not need to obtain capability information of a plurality of candidate devices.

In some embodiments, after the first sensing function network element determines the first sensing node set and the second sensing node set according to the first information, the method further includes:
in a case that a preset update condition is met, updating, by the first sensing function network element, at least one of the first sensing node set and the second sensing node set, where
the preset update condition includes at least one of the following: at least one first sensing node in the first sensing node set is not suitable for executing the first sensing service; at least one second sensing node in the second sensing node set is switched to the first sensing node set and used to execute the first sensing service; and at least one second sensing node is added to the second sensing node set.

In this embodiment of this application, at least one of the first sensing node set and the second sensing node set may be updated in real time according to a relative location between each sensing node in the L sensing nodes and a sensing object and a change in capability information of the sensing node.

Further, after determining the L sensing nodes for executing the first sensing service, the first sensing function network element may send sensing start information and/or the first information to the L sensing nodes, and the first sensing function network element sends release information to a candidate device other than the L sensing nodes.

The sensing start information is used to indicate that a candidate device is determined as a sensing node and may start to execute the first sensing service. The device release information is used to indicate that the candidate device is not determined as a sensing node and no longer participates in sensing node selection of the first sensing service.

After determining to execute the first sensing service, the first sensing node in the L sensing devices may send third feedback information to the first sensing function network element, where the third feedback information is used to instruct the first sensing node to determine to execute the first sensing service.

Further, in a sensing node selection process, the candidate device may further execute the following different response behavior in a process in which the sensing function network element starts to execute sensing node selection and send the third feedback information to the candidate device. For example, in some implementations, in a case that the first device is the first sensing node, before the step of obtaining, by a first device, target information, the method further includes at least one of the following:
in a case that the first device determines first signaling sent by the first sensing function network element, determining that the first device is occupied by the first sensing service until the first device receives second signaling, where the first signaling is signaling in a sensing node selection process, the second signaling is used to indicate that the first device is determined to be the first sensing node that executes the first sensing service, and the first sensing function network element is a sensing function network element that is used to invoke the first device to execute the first sensing service;
in a case that the first device receives first signaling sent by a second sensing function network element, determining that the first device is occupied by a second sensing service of the second sensing function network element until the first device receives third signaling or a timer expires, where the third signaling is used to indicate that the first device is determined not to be the first sensing node that executes the second sensing service, and the timer is associated with the second sensing service;
in a case that the first device monitors first signaling sent by any sensing function network element, continuing to monitor first signaling sent by each sensing function network element, and if the first device receives second signaling sent by the first sensing function network element before receiving second signaling sent by a third sensing function network element, sending, by the first device, first feedback information to the third sensing function network element, where the first feedback information is used to instruct the first device not to execute a sensing service of a corresponding sensing function network element, and the third sensing function network element is a sensing function network element that the first device acknowledges that first signaling has been sent but second signaling has not been sent; and
in a case that the first device monitors first signaling sent by a fourth sensing function network element, continuing to monitor first signaling sent by each sensing function network element, and if the first device receives the first signaling sent by the first sensing function network element before receiving second signaling sent by the fourth sensing function network element, and a global priority of a fourth sensing service of the fourth sensing function network element is lower than a global priority of the first sensing service, sending, by the first device, the first feedback information to the fourth sensing function network element.

For example, in some embodiments, when a candidate device receives first signaling of a sensing function network element 1 in a sensing node selection process, the candidate device is occupied by a sensing service 1 of the sensing function network element 1 until the candidate device receives third signaling sent by the sensing function network element 1 and starts to execute the sensing service 1, or the candidate device receives third signaling sent by the sensing function network element 1, or a timer corresponding to the sensing service 1 expires. The timer may be initialized when the candidate device receives any signaling of the sensing function network element 1 in the sensing node selection process. It should be understood that when first signaling of any sensing function network element in the sensing node selection process is received, a timer corresponding to a sensing service of the sensing function network element may be started or restarted. Before the timer expires, the candidate device may be considered as occupied by the sensing service of the sensing function network element. In this case, the sensing function network element may select the candidate device.

For example, in some embodiments, after receiving first signaling of a sensing service 1 of a sensing function network element 1 in a sensing node selection process, a candidate device continues to monitor first signaling of another sensing function network element for another sensing service. Before the candidate device receives second signaling of the sensing service 1, if the candidate device receives second signaling of a sensing service 2 of a sensing function network element 2, the candidate device executes the sensing service 2, and sends first feedback information to the sensing function network element 1, where the first feedback information indicates that the candidate device cannot execute the sensing service 1.

For example, in some embodiments, after receiving first signaling of a sensing service 1 of a sensing function network element 1 in a sensing node selection process, a candidate device continues to monitor sensing node selection signaling of another sensing function network element for another sensing service. Before the candidate device receives second signaling of the sensing service 1, if the candidate device receives first signaling of a sensing service 2 with a higher global priority, the candidate device no longer participates in sensing node selection of the sensing service 1, and sends first feedback information to the sensing function network element 1, where the first feedback information indicates that the candidate device cannot execute the sensing service 1.

In some embodiments, after the determining, by the first device, a signal parameter of a first signal according to the target information, the method further includes:
in a case that a preset condition is met, sending, by the first device, first indication information to a second device, where the first indication information is used to indicate an adjusted signal parameter; and
the preset condition includes at least one of the following:
the first device is the first sensing node, the second device includes the first sensing function network element, and the first sensing function network element participates in signal processing; and
the first device is the first sensing function network element, and the second device includes the first sensing node.

In this embodiment of this application, that the first sensing function network element participates in signal processing may be understood as that the first sensing function network element determines the target information. For example, the first sensing function network element may execute first arithmetic on echo data sent by the first sensing node or execute third arithmetic on an intermediate sensing result sent by the first sensing node, to obtain the target information.

In some embodiments, in a case that the first device is the first sensing node, after the determining, by the first device, a signal parameter of a first signal according to the target information, the method further includes:
executing, by the first device, the first sensing service according to an adjusted signal parameter.

To better understand this application, some examples are used for detailed description below.

In some embodiments, a sending device of a first sensing node and a receiving device of the first sensing node belong to a same device. In a case that the first sensing node executes a sensing service in a self-transmitting and self-receiving manner, a procedure of adaptive adjustment of a signal parameter is as follows:

Step 1: A first sensing function network element obtains first information related to a first sensing service, where an obtaining method includes:
receiving the first information from an application server; or
receiving a part of information in the first information from an application server, and mapping a remaining part in the first information according to the part of received information in the first information.

Step 2: The first sensing function network element selects, according to the first information, location information of a candidate device, and capability information of the candidate device, one or more first sensing nodes from scheduled candidate devices to execute the first sensing service. The first sensing node can execute, in a self-transmitting and self-receiving manner, sensing that meets a related requirement in the first information.

Step 3: The first sensing function network element or the first sensing node performs initial configuration on a signal parameter according to the first information, location information of the one or more first sensing nodes, and capability information of the one or more first sensing nodes.

Because location information and/or capability information of a plurality of first sensing nodes are the same or different, initial configurations on the signal parameter of the first sensing service executed by the plurality of first sensing nodes may be the same or different.

If it is determined that the initial configuration is executed by the first sensing function network element, after determining the initial configuration, the first sensing function network element sends the initial configuration of the signal parameter to the one or more first sensing nodes.

Step 4: The one or more first sensing nodes execute initial sensing according to a respective initial configuration of the signal parameter. The first sensing node generates and sends a first signal and receives the first signal according to the initial configuration of the signal parameter, to obtain echo data. After a sensing object corresponding to the first information is detected based on the echo data and target information of a predetermined quantity of sensing frames is obtained, a next step: an adaptive adjustment process of the signal parameter, is executed.

Step 5: The first sensing node executes adaptive adjustment on the signal parameter according to the target information, generates and sends the first signal and receives the first signal according to an adjusted signal parameter, to obtain echo data, and obtains the target information based on the echo data.

Finally, step 5 is cyclically executed until a sensing process ends.

In some embodiments, a sending device of a sensing node and a receiving device of the sensing node belong to different devices. In a case that the sending device sends a first signal and the receiving device receives the first signal to execute a sensing service, a produce of adaptive adjustment of a sensing update period is as follows:

Step 1: A first sensing function network element obtains first information related to a first sensing service, where an obtaining method includes:
receiving the first information from an application server; or
receiving a part of information in the first information from an application server, and mapping a remaining part in the first information according to the part of received information in the first information.

Step 2: The first sensing function network element selects, according to the first information, location information of a candidate device, and capability information of the candidate device, one or more first sensing nodes from scheduled candidate devices to execute the first sensing service. A part of a plurality of first sensing nodes are sending devices, and a part of a plurality of first sensing nodes are receiving devices.

Step 3: The first sensing function network element, the sending device, or the receiving device executes an initial configuration on a signal parameter according to the first information, location information of the sending device and the receiving device, and capability information of the sending device and the receiving device.

Because location information and/or capability information of a plurality of sending devices or receiving devices are the same or different, initial configurations on the signal parameter of the first sensing service executed by the plurality of sending devices or receiving devices may be the same or different.

After determining that the initial configuration is completed by any one of the first sensing function network element, the sending device, and the receiving device, the initial configuration of the signal parameter needs to be sent to at least one of the other two.

Step 4: The sending device generates and sends a first signal according to the initial configuration of the signal parameter, and the receiving device receives the first signal according to the initial configuration of the signal parameter, to obtain echo data. After a sensing object corresponding to the first information is detected based on the echo data and target information of a predetermined quantity of sensing frames is obtained, a next step: an adaptive adjustment process of the signal parameter, is executed.

Step 5: One of the first sensing function network element, the sending device, and the receiving device executes adaptive adjustment on the signal parameter according to the target information, and sends an adjusted signal parameter to at least one of the other two. Then the sending device generates and sends the first signal according to the adjusted signal parameter, and the receiving device receives the first signal according to the adjusted signal parameter, to obtain the echo data. Then the target information is then obtained based on the echo data.

Finally, step 5 is cyclically executed until a sensing process ends.

In some embodiments, adaptive adjustment may be executed on a time-dimensional signal parameter. The time-dimensional signal parameter includes a sensing signal period, a sensing frame period, and a sensing update period.

The first sensing function network element and/or the first sensing node set/sets an initial sensing signal period, an initial sensing frame period, and an initial sensing update period according to the first information.

The first sensing node sends, receives, and processes a sensing signal according to the initial sensing signal period, the initial sensing frame period, and the initial sensing update period, and exchanges a sensing measurement quantity and/or a sensing result and the signal parameter with the sensing function network element.

That the first sensing function network element and/or the first sensing node execute/executes an adaptive configuration on a sensing signal waveform according to the sensing result includes:
adaptively updating, by the first sensing function network element and/or the first sensing node, a configuration of the sensing signal period according to a first parameter of a sensing object;
adaptively updating, by the first sensing function network element and/or the first sensing node, a configuration of the sensing frame period according to echo signal quality of the sensing object; and
adaptively updating, by the first sensing function network element and/or the first sensing node, a configuration of the sensing update period according to a performance indicator of the first parameter of the sensing object.

The first sensing node sends, receives, and processes the sensing signal according to the updated sensing signal period, the updated sensing frame period, and the updated sensing update period, and exchanges the sensing measurement quantity and/or the sensing result and the signal parameter with the first sensing function network element.

In some embodiments, joint adaptive adjustment may be executed on two signal parameters: a power and a bandwidth.

For example, in a respiration detection scenario, a device A sends a first signal, at least one diameter of the first signal is reflected by a fluctuating chest cavity of a human body during breathing to a second device for receiving, and the device A extracts a respiration rate by means of signal processing.

A common method for processing the first signal is to process a first signal of one subcarrier or one Resource Block (RB) of an OFDM waveform to obtain the respiration rate. In a process of a respiration detection method, a distribution range of a transmit power of the device A in frequency domain is greater than or equal to the one subcarrier or the one RB.

When the device B executes respiration detection signal processing, if echo signal quality of the one subcarrier or the one RB is less than a threshold A, the respiration rate cannot be correctly extracted or a confidence of the extracted respiration rate is less than the threshold B. In this case, a transmit power of the one subcarrier or the one RB should be appropriately increased, and a total transmit power of the device A is a constant. Therefore, a bandwidth for transmitting the first signal by the device A needs to be correspondingly reduced.

On the contrary, if the echo signal quality of the one subcarrier or the one RB is greater than the threshold A, the respiration rate can be correctly extracted or the confidence of the extracted respiration rate is greater than the threshold B, that is, a sensing requirement can be met. In this case, if the echo signal quality of the one subcarrier or the one RB is greater than a threshold C, or the confidence of the extracted respiration rate is greater than a threshold D, the transmit power of the one subcarrier or the one RB can be appropriately reduced, so that the bandwidth for transmitting the first signal by the device A can be appropriately increased.

In some embodiments, a value of increasing or decreasing the transmit power and the bandwidth may be determined in any one of the following calculation manners:
calculating a target value of the transmit power or the bandwidth according to echo signal quality at a current moment and the threshold A, the threshold B, the threshold C, or the threshold D;
adjusting the transmit power or the bandwidth in a step-by-step manner by using a preset value of the transmit power or the bandwidth; and
setting the transmit power and the bandwidth based on a preset value table of the transmit power and the bandwidth in a table lookup manner.

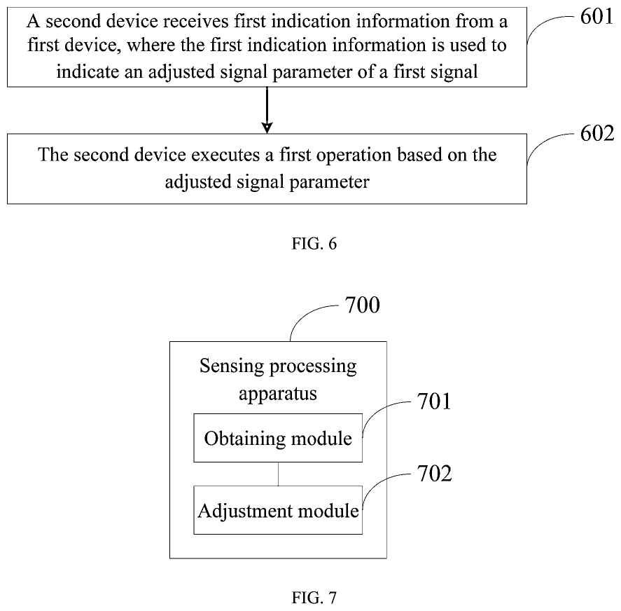

Referring to FIG. 6, an embodiment of this application further provides another sensing processing method. As shown in FIG. 6, the sensing processing method includes:

Step 601: A second device receives first indication information from a first device, where the first indication information is used to indicate an adjusted signal parameter of a first signal, and the first signal is used to execute a first sensing service.

Step 602: The second device executes a first operation based on the adjusted signal parameter.

The first operation includes any one of the following:
in a case that the second device is a first sensing function network element, executing, according to the adjusted signal parameter, second arithmetic on echo data received from the first device, to obtain target information, where the echo data is echo data obtained by the first device by executing the first sensing service based on the adjusted signal parameter;
in a case that the second device is the first sensing function network element, executing, according to the adjusted signal parameter, third arithmetic on an intermediate sensing result received from the first device, to obtain the target information, where the intermediate sensing result is a result obtained by the first device by executing first arithmetic on the echo data, the first arithmetic is a part of the second arithmetic, and the third arithmetic is remaining arithmetic other than the first arithmetic in the second arithmetic; and
in a case that the second device is a first sensing node, sending and/or receiving the first signal according to the adjusted signal parameter.

In some embodiments, in a case that the second device is the first sensing node, the first operation further includes any one of the following:
executing the first arithmetic on the echo data obtained by the second device by executing the first sensing service based on the adjusted signal parameter, to obtain the intermediate sensing result; and
executing the second arithmetic on the echo data obtained by the second device by executing the first sensing service based on the adjusted signal parameter, to obtain the target information.

In some embodiments, the signal parameter includes at least two of the following: first time resource information, a sensing signal period, a sensing update period, a sensing frame period, a bandwidth, an antenna aperture, a transmit power, and a beam direction.

In some embodiments, the first time resource information includes any one of the following:
a fixed time resource for being allocated to the first sensing service; and
a time unit and a time resource allocation ratio that is used to execute the first sensing service within the time unit.

In some embodiments, the target information includes at least one of the following: echo signal quality of a first sensing frame, a first parameter of the first sensing frame, a predicted value of echo signal quality of a second sensing frame, a predicted value of a first parameter of the second sensing frame, and a first indicator of the first parameter, where the first parameter is used to indicate at least one of location information and motion information of a sensing object, the first indicator is used to indicate sensing performance of the sensing object, and the second sensing frame is located after the first sensing frame.

In some embodiments, the echo signal quality may include or represent at least one of the following: an echo signal power, an SNR, an SINR, an RSRP, and RSRQ.

In some embodiments, the first parameter includes at least one of the following:
a parameter in a polar coordinate system; and
a parameter in a rectangular coordinate system.

In some embodiments, the first indicator includes at least one of the following:
a variance or a standard deviation of a residual;
a covariance of a prediction error; and
a covariance of a state estimation error.

In some embodiments, in a case that the second device is the first sensing node, after the executing, by the second device, a first operation based on the adjusted signal parameter, the method further includes:
sending, by the second device, second information to the first device, where the second information includes the echo data, the intermediate sensing result obtained by executing the first arithmetic on the echo data, or the target information obtained by executing the second arithmetic on the echo data, where the echo data is data obtained by the first sensing node by executing the first sensing service based on the adjusted signal parameter, and the first arithmetic is a part of the second arithmetic.

The sensing processing method provided in this embodiment of this application may be executed by a sensing processing apparatus. In the embodiments of this application, an example in which the sensing processing apparatus executes the sensing processing method is used to describe the sensing processing apparatus provided in the embodiments of this application.

Referring to FIG. 7, an embodiment of this application provides a sensing processing apparatus, applied to a first device. As shown in FIG. 7, the sensing processing apparatus 700 includes:
an obtaining module 701, configured to obtain target information, where the target information is determined based on a result obtained by executing a first sensing service; and
an adjustment module 702, configured to determine a signal parameter of a first signal according to the target information, where the first signal is used to execute the first sensing service.

In some embodiments, the signal parameter includes at least two of the following: first time resource information, a sensing signal period, a sensing update period, a sensing frame period, a bandwidth, an antenna aperture, a transmit power, and a beam direction.

In some embodiments, the first time resource information includes any one of the following:
a fixed time resource for being allocated to the first sensing service; and
a time unit and a time resource allocation ratio that is used to execute the first sensing service within the time unit.

In some embodiments, the target information includes at least one of the following: echo signal quality of a first sensing frame, a first parameter of the first sensing frame, a predicted value of echo signal quality of a second sensing frame, a predicted value of a first parameter of the second sensing frame, and a first indicator of the first parameter, where the first parameter is used to indicate at least one of location information and motion information of a sensing object, the first indicator is used to indicate sensing performance of the sensing object, and the second sensing frame is located after the first sensing frame.

In some embodiments, the echo signal quality may include or represent at least one of the following: an echo signal power, an SNR, an SINR, an RSRP, and RSRQ.

In some embodiments, the first parameter includes at least one of the following:
a parameter in a polar coordinate system; and
a parameter in a rectangular coordinate system.

In some embodiments, the first indicator includes at least one of the following:
a variance or a standard deviation of a residual;
a covariance of a prediction error; and
a covariance of a state estimation error.

In some embodiments, the sensing processing apparatus 700 further includes a first determining module.

The obtaining module 701 is further configured to obtain first information.

The first determining module is configured to determine an initial configuration of the signal parameter of the first signal according to the first information, and capability information and location information that are of a first sensing node, where the initial configuration is used to execute initial sensing.

The first sensing node is the first device, or the first sensing node is a sensing node invoked by the first device to execute the first sensing service; and the first information includes at least one of the following: a sensing service type, an execution time of a sensing service, a global priority of a sensing service, a sensing object type, sensing prior information, a sensing measurement quantity, a sensing quality of service QoS requirement, a signal processing algorithm, and a data processing algorithm.

In some embodiments, in a case that the first device is a first sensing function network element, the first determining module is further configured to determine, according to the first information, a first sensing node set used to execute the first sensing service and a second sensing node set used to execute the first sensing service after switching, where the first sensing node set includes at least one first sensing node, and the second sensing node set includes zero or at least one second sensing node.

In some embodiments, the sensing processing apparatus 700 further includes:
an updating module, configured to: in a case that a preset update condition is met, update at least one of the first sensing node set and the second sensing node set.

The preset update condition includes at least one of the following: at least one first sensing node in the first sensing node set is not suitable for executing the first sensing service; at least one second sensing node in the second sensing node set is switched to the first sensing node set and used to execute the first sensing service; and at least one second sensing node is added to the second sensing node set.

In some embodiments, the obtaining module is configured to execute any one of the following:
in a case that the first device is the first sensing function network element, receiving second information from the first sensing node, and determining the target information based on the second information, where the second information includes echo data, an intermediate sensing result obtained by executing first arithmetic on the echo data, or the target information obtained by executing second arithmetic on the echo data, where the echo data is data obtained by the first sensing node by executing the first sensing service based on the current signal parameter, and the first arithmetic is a part of the second arithmetic;
in a case that the first device is the first sensing node, executing the first sensing service based on the current signal parameter to obtain the echo data, and executing the second arithmetic on the echo data to obtain the target information; and
in a case that the first device is the first sensing node, sending third information to the first sensing function network element, and receiving the target information sent by the first sensing function network element, where the third information includes the echo data or the intermediate sensing result obtained by executing the first arithmetic on the echo data, and the target information is target information determined by the first sensing function network element based on the third information.

In some embodiments, the sensing processing apparatus 700 further includes:
a first sending module, configured to: in a case that a preset condition is met, send first indication information to a second device, where the first indication information is used to indicate an adjusted signal parameter; and
the preset condition includes at least one of the following:
the first device is the first sensing node, the second device includes the first sensing function network element, and the first sensing function network element participates in signal processing; and
the first device is the first sensing function network element, and the second device includes the first sensing node.

In some embodiments, in a case that the first device is the first sensing node, the sensing processing apparatus 700 further includes:
a second execution module, configured to execute the first sensing service according to an adjusted signal parameter.

In some embodiments, in a case that the first device is the first sensing node, the sensing processing apparatus 700 further includes a third execution module, configured to execute at least one of the following:
in a case that the first device determines first signaling sent by the first sensing function network element, determining that the first device is occupied by the first sensing service until the first device receives second signaling, where the first signaling is signaling in a sensing node selection process, the second signaling is used to indicate that the first device is determined to be the first sensing node that executes the first sensing service, and the first sensing function network element is a sensing function network element that is used to invoke the first device to execute the first sensing service;
in a case that the first device receives first signaling sent by a second sensing function network element, determining that the first device is occupied by a second sensing service of the second sensing function network element until the first device receives third signaling or a timer expires, where the third signaling is used to indicate that the first device is determined not to be the first sensing node that executes the second sensing service, and the timer is associated with the second sensing service;
in a case that the first device monitors first signaling sent by any sensing function network element, continuing to monitor first signaling sent by each sensing function network element, and if the first device receives second signaling sent by the first sensing function network element before receiving second signaling sent by a third sensing function network element, sending first feedback information to the third sensing function network element, where the first feedback information is used to instruct the first device not to execute a sensing service of a corresponding sensing function network element, and the third sensing function network element is a sensing function network element that the first device acknowledges that first signaling has been sent but second signaling has not been sent; and
in a case that the first device monitors first signaling sent by a fourth sensing function network element, continuing to monitor first signaling sent by each sensing function network element, and if the first device receives the first signaling sent by the first sensing function network element before receiving second signaling sent by the fourth sensing function network element, and a global priority of a fourth sensing service of the fourth sensing function network element is lower than a global priority of the first sensing service, sending the first feedback information to the fourth sensing function network element.

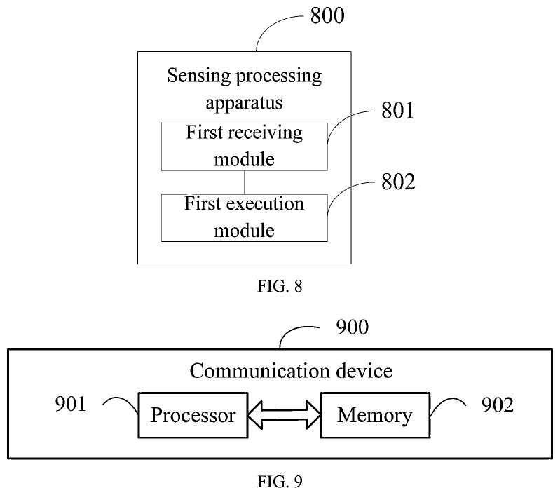

Referring to FIG. 8, an embodiment of this application provides a sensing processing apparatus, applied to a second device. As shown in FIG. 8, the sensing processing apparatus 800 includes:
a first receiving module 801, configured to receive first indication information from a first device, where the first indication information is used to indicate an adjusted signal parameter of a first signal, and the first signal is used to execute a first sensing service; and
a first execution module 802, configured to execute a first operation based on the adjusted signal parameter, where
the first operation includes any one of the following:
in a case that the second device is a first sensing function network element, executing, according to the adjusted signal parameter, second arithmetic on echo data received from the first device, to obtain target information, where the echo data is echo data obtained by the first device by executing the first sensing service based on the adjusted signal parameter;
in a case that the second device is the first sensing function network element, executing, according to the adjusted signal parameter, third arithmetic on an intermediate sensing result received from the first device, to obtain the target information, where the intermediate sensing result is a result obtained by the first device by executing first arithmetic on the echo data, the first arithmetic is a part of the second arithmetic, and the third arithmetic is remaining arithmetic other than the first arithmetic in the second arithmetic; and
in a case that the second device is a first sensing node, sending and/or receiving the first signal according to the adjusted signal parameter.

In some embodiments, in a case that the second device is the first sensing node, the first operation further includes any one of the following:
executing the first arithmetic on the echo data obtained by the second device by executing the first sensing service based on the adjusted signal parameter, to obtain the intermediate sensing result; and
executing the second arithmetic on the echo data obtained by the second device by executing the first sensing service based on the adjusted signal parameter, to obtain the target information.

In some embodiments, the signal parameter includes at least two of the following: first time resource information, a sensing signal period, a sensing update period, a sensing frame period, a bandwidth, an antenna aperture, a transmit power, and a beam direction.

In some embodiments, the first time resource information includes any one of the following:
a fixed time resource for being allocated to the first sensing service; and
a time unit and a time resource allocation ratio that is used to execute the first sensing service within the time unit.

In some embodiments, the target information includes at least one of the following: echo signal quality of a first sensing frame, a first parameter of the first sensing frame, a predicted value of echo signal quality of a second sensing frame, a predicted value of a first parameter of the second sensing frame, and a first indicator of the first parameter, where the first parameter is used to indicate at least one of location information and motion information of a sensing object, the first indicator is used to indicate sensing performance of the sensing object, and the second sensing frame is located after the first sensing frame.

In some embodiments, the echo signal quality may include or represent at least one of the following: an echo signal power, an SNR, an SINR, an RSRP, and RSRQ.

In some embodiments, the first parameter includes at least one of the following:
a parameter in a polar coordinate system; and
a parameter in a rectangular coordinate system.

In some embodiments, the first indicator includes at least one of the following:
a variance or a standard deviation of a residual;
a covariance of a prediction error; and
a covariance of a state estimation error.

In some embodiments, in a case that the second device is the first sensing node, the sensing processing apparatus 800 further includes:
a second sending module, configured to send second information to the first device, where the second information includes the echo data, the intermediate sensing result obtained by executing the first arithmetic on the echo data, or the target information obtained by executing the second arithmetic on the echo data, where the echo data is data obtained by the first sensing node by executing the first sensing service based on the adjusted signal parameter, and the first arithmetic is a part of the second arithmetic.

The sensing processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a Network Attached Storage (NAS), or the like. This is not specifically limited in this embodiment of this application.

The sensing processing apparatus provided in this embodiment of this application can implement the processes implemented in the method embodiments in FIG. 2 to FIG. 6, and achieve a same technical effect. To avoid repetition, details are not described herein again.

For example, as shown in FIG. 9, an embodiment of this application further provides a communication device 900, including a processor 901 and a memory 902. The memory 902 stores a program or an instruction that can be run on the processor 901, and the program or the instruction is executed by the processor 901 to implement the steps of the foregoing sensing processing method embodiment, and a same technical effect can be achieved. To avoid repetition, details are not described herein again.

An embodiment of this application further provides a terminal, including a processor and a communication interface. When the terminal is a first device, the communication interface is configured to obtain target information, where the target information is determined based on a result obtained by executing a first sensing service; and the processor is configured to adjust a signal parameter of a first signal according to the target information, where the first signal is used to execute the first sensing service; or
when the terminal is a second device, the communication interface is configured to receive first indication information from a first device, where the first indication information is used to indicate an adjusted signal parameter of a first signal, and the first signal is used to execute a first sensing service; and the processor is configured to execute a first operation based on the adjusted signal parameter, where
the first operation includes sending and/or receiving the first signal according to the adjusted signal parameter.

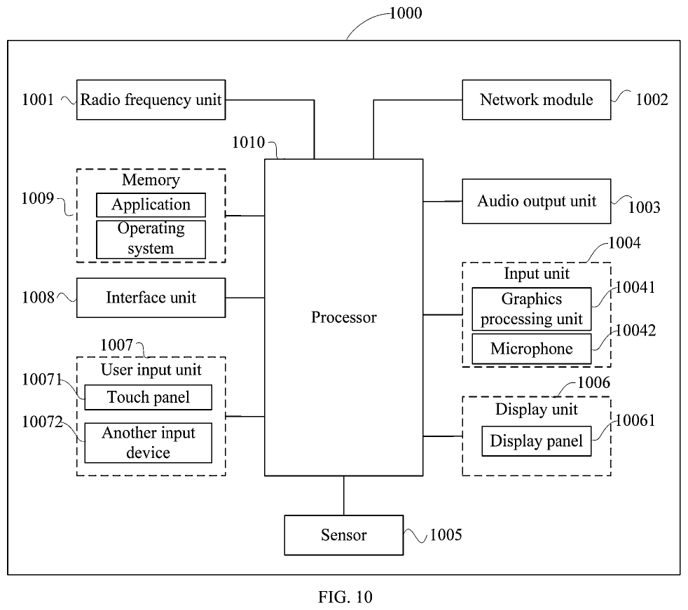

This terminal embodiment corresponds to the foregoing method embodiment on the terminal side. Each implementation process and implementation of the foregoing method embodiment may be applicable to this terminal embodiment, and a same technical effect can be achieved. For example, FIG. 10 is a schematic diagram of a hardware structure of a terminal according to an embodiment of this application.

A terminal 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include the power supply (for example, a battery) that supplies power to each component. The power supply may be logically connected to the processor 1010 by using a power supply management system, so as to manage functions such as charging, discharging, and power consumption by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that, in this embodiment of this application, the input unit 1004 may include a Graphics Processing Unit (GPU) 10041 and a microphone 10042, and the graphics processing unit 10041 processes image data of a still image or a video that is obtained by an image capturing apparatus (for example, a camera) in a video capturing mode or an image capturing mode. The display unit 1006 may include a display panel 10061. The display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (for example, a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Usually, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1009 in this embodiment of this application includes but is not limited to these memories and a memory of any other proper type.

The processor 1010 may include one or more processing units. In some embodiments, an application processor and a modem processor are integrated into the processor 1010. The application processor mainly processes an operating system, a user interface, an application, and the like. The modem processor mainly processes a wireless communication signal, for example, a baseband processor. It can be understood that the modem processor may not be integrated into the processor 1010.

When the terminal is a first device, the radio frequency unit 1001 is configured to obtain target information, where the target information is determined based on a result obtained by executing a first sensing service; and the processor 1010 is configured to adjust a signal parameter of a first signal according to the target information, where the first signal is used to execute the first sensing service; or
when the terminal is a second device, the radio frequency unit 1001 is configured to receive first indication information from a first device, where the first indication information is used to indicate an adjusted signal parameter of a first signal, and the first signal is used to execute a first sensing service; and the processor is configured to execute a first operation based on the adjusted signal parameter, where
the first operation includes sending and/or receiving the first signal according to the adjusted signal parameter.

An embodiment of this application further provides a network side device, including a processor and a communication interface. When the communication device is a first device, the communication interface is configured to obtain target information, where the target information is determined based on a result obtained by executing a first sensing service; and the processor is configured to adjust a signal parameter of a first signal according to the target information, where the first signal is used to execute the first sensing service; or
when the communication device is a second device, the communication interface is configured to receive first indication information from a first device, where the first indication information is used to indicate an adjusted signal parameter of a first signal, and the first signal is used to execute a first sensing service; and the processor is configured to execute a first operation based on the adjusted signal parameter, where
the first operation includes any one of the following:
in a case that the second device is a first sensing function network element, executing, according to the adjusted signal parameter, second arithmetic on echo data received from the first device, to obtain target information, where the echo data is echo data obtained by the first device by executing the first sensing service based on the adjusted signal parameter;
in a case that the second device is the first sensing function network element, executing, according to the adjusted signal parameter, third arithmetic on an intermediate sensing result received from the first device, to obtain the target information, where the intermediate sensing result is a result obtained by the first device by executing first arithmetic on the echo data, the first arithmetic is a part of the second arithmetic, and the third arithmetic is remaining arithmetic other than the first arithmetic in the second arithmetic; and
in a case that the second device is a first sensing node, sending and/or receiving the first signal according to the adjusted signal parameter.

This network side device embodiment corresponds to the foregoing method embodiment on the network side device. Each implementation process and implementation of the foregoing method embodiment may be applicable to this network side device embodiment, and a same technical effect can be achieved.

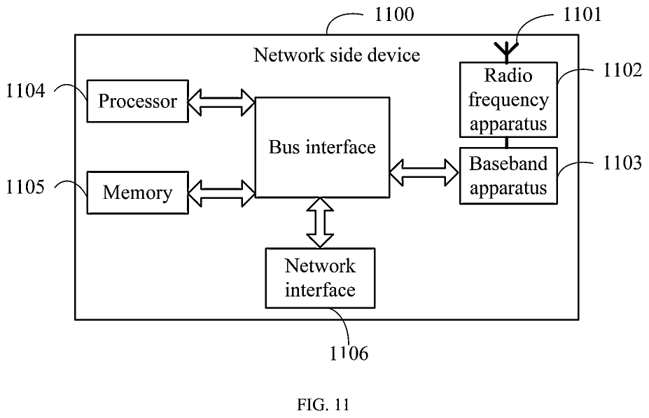

For example, an embodiment of this application further provides a network side device. As shown in FIG. 11, a network side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information by using the antenna 1101.

In the foregoing embodiment, the method performed by the network side device may be implemented in the baseband apparatus 1103. The baseband apparatus 1103 includes a baseband processor.

The baseband apparatus 1103 may include, for example, at least one baseband board, where a plurality of chips are disposed on the baseband board. As shown in FIG. 11, one chip is, for example, the baseband processor, is connected to the memory 1105 through a bus interface, to invoke a program in the memory 1105 to perform the operations of the network device shown in the foregoing method embodiment.

The network side device may further include a network interface 1106, and the interface is, for example, a Common Public Radio Interface (CPRI).

For example, the network side device 1100 in this embodiment of this application further includes an instruction or a program that is stored in the memory 1105 and that can be run on the processor 1104. The processor 1104 invokes the instruction or the program in the memory 1105 to perform the method performed by the modules shown in FIG. 7 or FIG. 8, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing sensing processing method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing sensing processing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing sensing processing method embodiment, and a same technical effect can be achieved. To avoid repetition, details are not described herein again.

An embodiment of this application further provides a communication system, including a first device and a second device. The first device is configured to execute the processes of the foregoing method embodiments in FIG. 2 and the above, and the second device is configured to execute the processes of the foregoing method embodiments in FIG. 6 and the above, and a same technical effect can be achieved. To avoid repetition, details are not described herein again.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In some embodiments, the technical solutions of this application entirely or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms without departing from the purpose of this application and the protection scope of the claims, all of which fall within the protection of this application.

1. A sensing processing method, comprising:
obtaining, by a first device, target information, wherein the target information is determined based on a result obtained by executing a first sensing service; and
determining, by the first device, a signal parameter of a first signal according to the target information, wherein the first signal is used to execute the first sensing service.

2. The sensing processing method according to claim 1, wherein the signal parameter comprises at least two of the following: first time resource information, a sensing signal period, a sensing update period, a sensing frame period, a bandwidth, an antenna aperture, a transmit power, or a beam direction.

3. The sensing processing method according to claim 2, wherein the first time resource information comprises any one of the following:
a fixed time resource for being allocated to the first sensing service; or
a time unit and a time resource allocation ratio that is used to execute the first sensing service within the time unit.

4. The sensing processing method according to claim 1, wherein the target information comprises at least one of the following: echo signal quality of a first sensing frame, a first parameter of the first sensing frame, a predicted value of echo signal quality of a second sensing frame, a predicted value of a first parameter of the second sensing frame, or a first indicator of the first parameter,
wherein:
the first parameter is used to indicate at least one of location information or motion information of a sensing object,
the first indicator is used to indicate sensing performance of the sensing object, and
the second sensing frame is located after the first sensing frame.

5. The sensing processing method according to claim 4, wherein the echo signal quality comprises at least one of the following: an echo signal power, an echo signal-to-noise ratio, an echo signal to interference plus noise ratio, a reference signal received power, or reference signal received quality.

6. The sensing processing method according to claim 5, wherein the first parameter comprises at least one of the following:
a radial distance of the sensing object relative to a sensing node;
a radial speed of the sensing object relative to the sensing node;
an angle of the sensing object relative to the sensing node;
coordinates of the sensing object in a rectangular coordinate system; or
a speed of the sensing object in the rectangular coordinate system.

7. The sensing processing method according to claim 5, wherein the first indicator comprises at least one of the following:
a variance or a standard deviation of a residual;
a covariance of a prediction error; or
a covariance of a state estimation error.

8. The sensing processing method according to claim 1, wherein before obtaining, by the first device, the target information, the method further comprises:
obtaining, by the first device, first information; and
determining, by the first device, an initial configuration of the signal parameter of the first signal according to the first information, and capability information and location information that are of a first sensing node,
wherein:
the initial configuration is used to execute initial sensing, and
the first sensing node is the first device, or the first sensing node is a sensing node invoked by the first device to execute the first sensing service; and the first information comprises at least one of the following: a sensing service type, an execution time of a sensing service, a global priority of a sensing service, a sensing object type, sensing prior information, a sensing measurement quantity, a sensing Quality Of Service (QOS) requirement, a signal processing algorithm, or a data processing algorithm.

9. The sensing processing method according to claim 8, wherein when the first device is a first sensing function network element, before determining, by the first device, the initial configuration of the signal parameter of the first signal according to the first information, and the capability information and the location information that are of the first sensing node, the method further comprises:
determining, by the first device according to the first information, a first sensing node set used to execute the first sensing service and a second sensing node set used to execute the first sensing service after switching, wherein the first sensing node set comprises at least one first sensing node, and the second sensing node set comprises zero or at least one second sensing node.

10. The sensing processing method according to claim 9, wherein after the first sensing function network element determining the first sensing node set and the second sensing node set according to the first information, the method further comprises:
when a preset update condition is met, updating, by the first sensing function network element, at least one of the first sensing node set or the second sensing node set, wherein
the preset update condition comprises at least one of the following:
at least one first sensing node in the first sensing node set is not suitable for executing the first sensing service;
at least one second sensing node in the second sensing node set is switched to the first sensing node set and used to execute the first sensing service; or
at least one second sensing node is added to the second sensing node set.

11. The sensing processing method according to claim 1, wherein obtaining, by the first device, the target information comprises any one of the following:
when the first device is the first sensing function network element, receiving, by the first device, second information from the first sensing node, and determining the target information based on the second information, wherein the second information comprises echo data, an intermediate sensing result obtained by executing first arithmetic on the echo data, or the target information obtained by executing second arithmetic on the echo data, wherein the echo data is data obtained by the first sensing node by executing the first sensing service based on the current signal parameter, and the first arithmetic is a part of the second arithmetic;
when the first device is the first sensing node, executing, by the first device, the first sensing service based on the current signal parameter to obtain the echo data, and executing the second arithmetic on the echo data to obtain the target information; or
when the first device is the first sensing node, sending, by the first device, third information to the first sensing function network element, and receiving the target information sent by the first sensing function network element, wherein the third information comprises the echo data or the intermediate sensing result obtained by executing the first arithmetic on the echo data, and the target information is target information determined by the first sensing function network element based on the third information.

12. The sensing processing method according to claim 1, wherein after determining, by the first device, the signal parameter of the first signal according to the target information, the method further comprises:
when a preset condition is met, sending, by the first device, first indication information to a second device, wherein the first indication information is used to indicate an adjusted signal parameter; and
the preset condition comprises at least one of the following:
the first device is the first sensing node, the second device comprises the first sensing function network element, and the first sensing function network element participates in signal processing; or
the first device is the first sensing function network element, and the second device comprises the first sensing node.

13. The sensing processing method according to claim 1, wherein when the first device is the first sensing node, after determining, by the first device, the signal parameter of the first signal according to the target information, the method further comprises:
executing, by the first device, the first sensing service according to an adjusted signal parameter.

14. The sensing processing method according to claim 1, wherein when the first device is the first sensing node, before obtaining, by the first device, the target information, the method further comprises at least one of the following:
when the first device determines first signaling sent by the first sensing function network element, determining that the first device is occupied by the first sensing service until the first device receives second signaling, wherein the first signaling is signaling in a sensing node selection process, the second signaling is used to indicate that the first device is determined to be the first sensing node that executes the first sensing service, and the first sensing function network element is a sensing function network element that is used to invoke the first device to execute the first sensing service;
when the first device receives first signaling sent by a second sensing function network element, determining that the first device is occupied by a second sensing service of the second sensing function network element until the first device receives third signaling or a timer expires, wherein the third signaling is used to indicate that the first device is determined not to be the first sensing node that executes the second sensing service, and the timer is associated with the second sensing service;
when the first device monitors first signaling sent by any sensing function network element, continuing to monitor first signaling sent by each sensing function network element, and when the first device receives second signaling sent by the first sensing function network element before receiving second signaling sent by a third sensing function network element, sending, by the first device, first feedback information to the third sensing function network element, wherein the first feedback information is used to instruct the first device not to execute a sensing service of a corresponding sensing function network element, and the third sensing function network element is a sensing function network element that the first device acknowledges that first signaling has been sent but second signaling has not been sent; or
when the first device monitors first signaling sent by a fourth sensing function network element, continuing to monitor first signaling sent by each sensing function network element, and when the first device receives the first signaling sent by the first sensing function network element before receiving second signaling sent by the fourth sensing function network element, and a global priority of a fourth sensing service of the fourth sensing function network element is lower than a global priority of the first sensing service, sending, by the first device, the first feedback information to the fourth sensing function network element.

15. A sensing processing method, comprising:
receiving, by a second device, first indication information from a first device, wherein the first indication information is used to indicate an adjusted signal parameter of a first signal, and the first signal is used to execute a first sensing service; and
executing, by the second device, a first operation based on the adjusted signal parameter, wherein
the first operation comprises any one of the following:
when the second device is a first sensing function network element, executing, according to the adjusted signal parameter, second arithmetic on echo data received from the first device, to obtain target information, wherein the echo data is echo data obtained by the first device by executing the first sensing service based on the adjusted signal parameter;
when the second device is the first sensing function network element, executing, according to the adjusted signal parameter, third arithmetic on an intermediate sensing result received from the first device, to obtain the target information, wherein the intermediate sensing result is a result obtained by the first device by executing first arithmetic on the echo data, the first arithmetic is a part of the second arithmetic, and the third arithmetic is remaining arithmetic other than the first arithmetic in the second arithmetic; or
when the second device is a first sensing node, sending or receiving the first signal according to the adjusted signal parameter.

16. The sensing processing method according to claim 15, wherein when the second device is the first sensing node, the first operation further comprises any one of the following:
executing the first arithmetic on the echo data obtained by the second device by executing the first sensing service based on the adjusted signal parameter, to obtain the intermediate sensing result; or
executing the second arithmetic on the echo data obtained by the second device by executing the first sensing service based on the adjusted signal parameter, to obtain the target information.

17. The sensing processing method according to claim 15, wherein when the second device is the first sensing node, after executing, by the second device, the first operation based on the adjusted signal parameter, the method further comprises:
sending, by the second device, second information to the first device, wherein the second information comprises the echo data, the intermediate sensing result obtained by executing the first arithmetic on the echo data, or the target information obtained by executing the second arithmetic on the echo data, wherein the echo data is data obtained by the first sensing node by executing the first sensing service based on the adjusted signal parameter, and the first arithmetic is a part of the second arithmetic.

18. The sensing processing method according to claim 15, wherein when the second device is the first sensing function network element, after executing, by the second device, the first operation based on the adjusted signal parameter, the method further comprises:
sending, by the second device, the target information to the first device.

19. A communication device, comprising a processor; and a memory having a computer program or an instruction stored thereon, wherein the computer program or the instruction, when executed by the processor, causes the processor to implement operations comprising:
obtaining target information, wherein the target information is determined based on a result obtained by executing a first sensing service; and
determining a signal parameter of a first signal according to the target information, wherein the first signal is used to execute the first sensing service.

20. The communication device according to claim 19, wherein the signal parameter comprises at least two of the following: first time resource information, a sensing signal period, a sensing update period, a sensing frame period, a bandwidth, an antenna aperture, a transmit power, or a beam direction.

21. A communication device, comprising a processor; and a memory having a computer program or an instruction stored thereon, wherein the computer program or the instruction, when executed by the processor, causes the processor to implement operations comprising:
receiving, by a second device, first indication information from a first device, wherein the first indication information is used to indicate an adjusted signal parameter of a first signal, and the first signal is used to execute a first sensing service; and
executing, by the second device, a first operation based on the adjusted signal parameter, wherein
the first operation comprises any one of the following:
when the second device is a first sensing function network element, executing, according to the adjusted signal parameter, second arithmetic on echo data received from the first device, to obtain target information, wherein the echo data is echo data obtained by the first device by executing the first sensing service based on the adjusted signal parameter;
when the second device is the first sensing function network element, executing, according to the adjusted signal parameter, third arithmetic on an intermediate sensing result received from the first device, to obtain the target information, wherein the intermediate sensing result is a result obtained by the first device by executing first arithmetic on the echo data, the first arithmetic is a part of the second arithmetic, and the third arithmetic is remaining arithmetic other than the first arithmetic in the second arithmetic; or
when the second device is a first sensing node, sending or receiving the first signal according to the adjusted signal parameter.
